(19) United States
(12) Patent Application Publication
(10) Pub. No.: US 2013/0083935 A1
(43) Pub. Date: Apr. 4, 2013

(54) METHOD FOR TESTING AN AUDIO JACK OF A PORTABLE ELECTRONIC DEVICE

(71) Applicants: Tsung-Hao Yang, Taipei (TW); Feng-Wei Hsu, Taipei (TW); Shao-Tang Wang, Taipei (TW)

(72) Inventors: Tsung-Hao Yang, Taipei (TW); Feng-Wei Hsu, Taipei (TW); Shao-Tang Wang, Taipei (TW)

(73) Assignee: INVENTEC CORPORATION, Taipei (TW)

(21) Appl. No.: 13/336,879

(22) Filed: Dec. 23, 2011

(30) Foreign Application Priority Data
Sep. 30, 2011 (TW) 100135636

(51) Int. Cl. H04R 29/00

(52) U.S. Cl. 381/58

(57) ABSTRACT

A method for testing an audio jack of a portable electronic device is provided. The audio jack has a first sound channel, a second channel and a microphone. First, the first sound channel is controlled to play a designated audio file by the portable electronic device. Nest, the played sound is recorded into another recorded audio file by the portable electronic device at the same when the first sound channel is playing the designated audio file. Afterwards, the recorded audio file is played via the second sound channel by the portable electronic device. Finally, it is determined whether the another recorded audio file that is played matches with the designated audio file, and if the audio files match, it represents that the first sound channel, the second sound channel and the microphone have normal function.

This application claims the benefit of Taiwan application Serial No. 100135636, filed Sep. 30, 2011, the subject matter of which is incorporated herein by reference.

### BACKGROUND OF THE INVENTION

1. Field of the Invention

The invention relates in general to a method for testing an audio jack of a portable electronic device, and more particularly to a method for testing an audio jack of a portable electronic device, which can enable the test procedure to be simplified.

2. Description of the Related Art

Referring to FIG. 1, a schematic diagram of a conventional tablet computer and an audio-jack cable externally connected to an audio jack of the tablet computer is shown. As shown in FIG. 1, the audio-jack cable 100 of a conventional tablet computer normally includes a left channel line Left, a right channel line Right, a microphone signal line MIC and a ground line GND. During a whole machine test, it requires the operator to insert an earphone to the audio jack. The test procedure can be roughly classified into the following two kinds:

(1) First, the left (or right) sound channel is tested, then the right (or left) sound channel is tested, followed by sound recording via the microphone (MIC), and finally, the recording result is played.

(2) First, sound recording is performed via the microphone (MIC), then the recording result is played via the left sound channel (Left), and finally, the recording result is played via the right sound channel (Right).

Basically, the operator has to respectively judge if the output of the left sound channel and the right sound channel is normal and check if the recording function has no error, thereby leading to the following drawbacks:

1. The left/right sound channel and the recording function have to be tested separately and thus it requires at least three test operations for respectively testing recording function, the left sound channel and the right sound channel.

2. In recording, the sound used to be tested comes from the operator or an external audio source, which is not stable or constant, and thus influences the judgment of the test result.

3. The operator has to individually judge if the left or right sound channel has an output, and will easily omit to test one of the sound channels or get confused about their outputs after a long period of operation time.

### SUMMARY OF THE INVENTION

The invention is directed to a method for testing an audio jack of a portable electronic device. During the test, one of the sound channels is controlled to play a designated audio file and the played sound is recorded into another recorded audio file via the microphone in synchronization. Then, the recorded audio file is played via another sound channel. Thus, the operator only needs to judge if the speaker generates the designated sound, and if yes, if represents that the test of the left/right channel and microphone function is completed. Therefore, it can effectively simplify the test procedure and avoid the prior-art drawback that the operator easily omits to test or gets confused about the test result.

According to the present invention, a method for testing an audio jack of a portable electronic device is provided. The audio jack has a first sound channel, a second channel and a microphone. The method comprises the following steps. First, the first sound channel is controlled to play a designated audio file by the portable electronic device. Next, the played sound is recorded into another recorded audio file by the portable electronic device at the same when the first sound channel is playing the designated audio file. Afterwards, the recorded audio file is played via the second sound channel by the portable electronic device. Finally, it is determined whether the another recorded audio file that is played matches with the designated audio file, and if the audio files match, it represents that the first sound channel, the second sound channel and the microphone have normal function.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 (Prior Art) shows a schematic diagram of a conventional tablet computer and an audio-jack cable externally connected to an audio jack of the tablet computer.

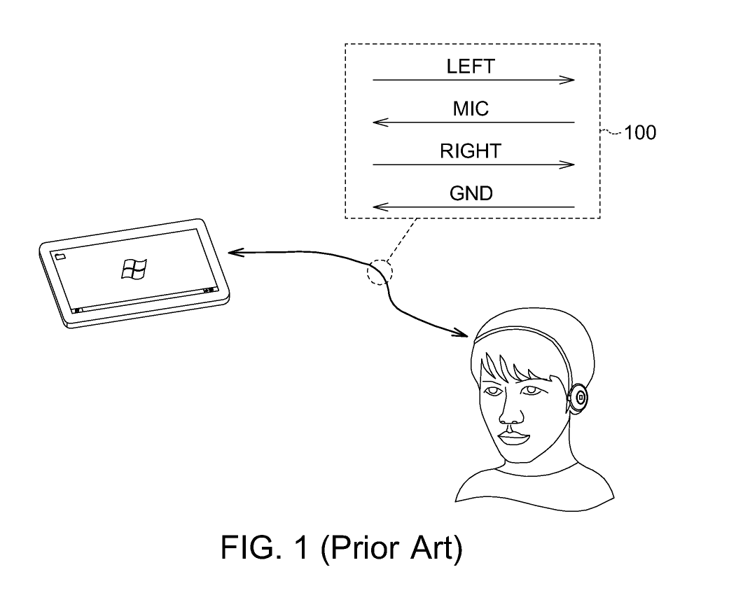

FIG. 2 shows a flow chart of the method for testing an audio jack of a portable electronic device according to a preferred embodiment.

FIG. 3 shows a schematic diagram of an audio-jack cable externally connected to the audio jack in FIG. 2.

### DETAILED DESCRIPTION OF THE INVENTION

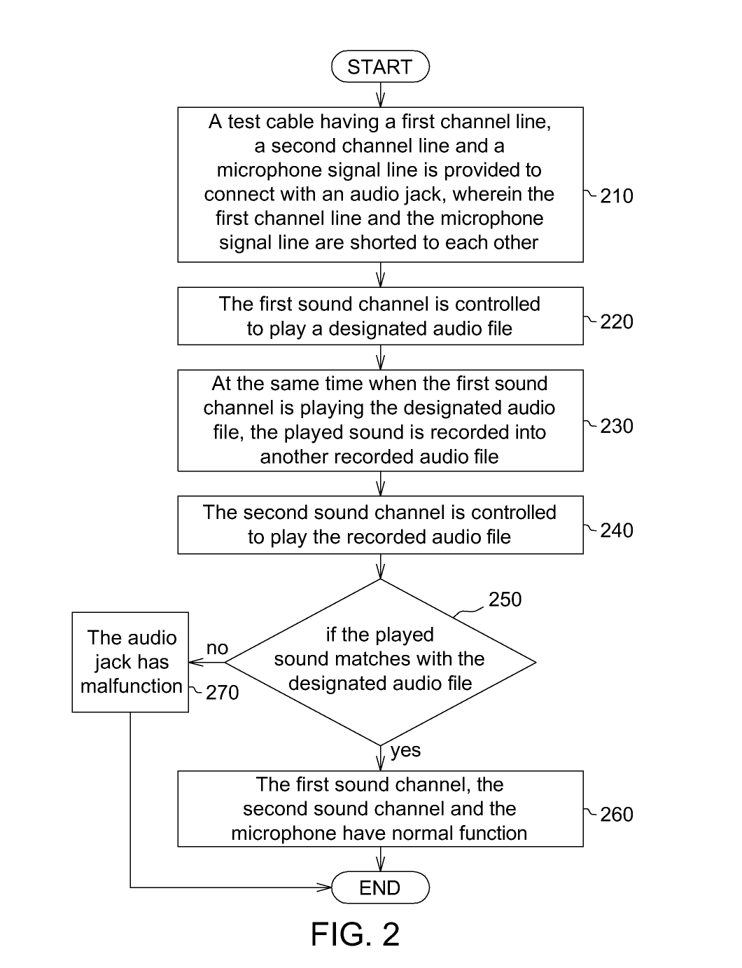

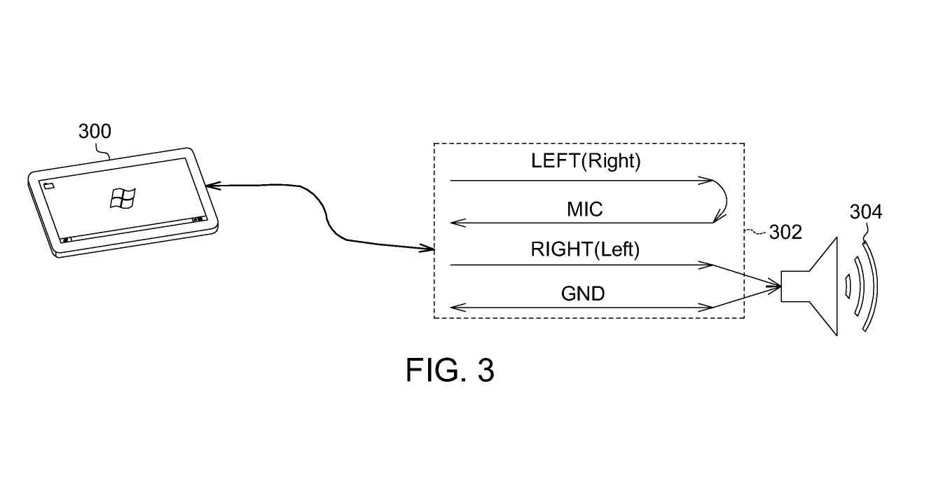

Referring to FIG. 2 and FIG. 3 at the same time, a flow chart of the method for testing an audio jack of a portable electronic device according to a preferred embodiment and a schematic diagram of an audio-jack cable externally connected to the audio jack in FIG. 2 are respectively shown. As shown in FIG. 3, the portable electronic device 300 under test, which is a tablet computer for instance, includes an audio jack (not shown in the figure) having a first sound channel, a second sound channel, a microphone and a ground line. For example, the first channel is a left (or right) sound channel and the second channel is a right (or left) sound channel.

First, in step 210, a test cable 302 is provided to connect with an audio jack. As shown in FIG. 3, the test cable 302 includes a first channel line S1, a second channel line S2, a microphone signal line MIC and a ground line GND respectively corresponding to the first sound channel, the second sound channel, the microphone and the ground line of the audio jack.

Besides, the first channel line S1 and the microphone signal line MIC are shorted to each other. That is, one of the sound channels is looped back to the microphone in order that the sound playing and recording can be performed in synchronization.

Next, in step 220, during the test, the first sound channel is controlled to play a designated audio file, such as a song, via an internal program of the to-be-tested portable electronic device 300, and the second sound channel is set to be mute.

Afterward, in step 230, at the same time when the first sound channel is playing the designated audio file, the played sound is recorded into another recorded audio file via the internal program of the portable electronic device 300. As mentioned above, since the first channel line S1 and the microphone signal line MIC form a loop, the played sound will be inputted to the audio jack via the microphone signal line MIC.

Following that, in step 240, after the played sound has been completely recorded into another recorded audio file, the recorded audio file is played by the internal program of the portable electronic device 300 and the second sound channel is controlled to play the recorded audio file. For example, the internal program of the portable electronic device 300 can be set to continuously play the recorded audio file via the second sound channel for a predetermined period of time, such as 20 seconds.

Finally, in step 250, the operator judges, through a speaker 304 of the test cable 302 shown in FIG. 3, whether the played sound matches with the designated sound (audio file). If the two match, that is, the speaker 304 generates the designated sound, it represents that the first sound channel, the second sound channel and the microphone recording all have normal function, as shown in step 260, and then the operator can stop the sound playing.

If it is determined that the played sound does not match with the designated sound, that is, the speaker 304 may generate no sound or the sound generated by the speaker 304 is not the designated sound, it represents that at least one of the first sound channel, the second sound channel and the microphone has malfunction and requires further check and repair, as shown in step 270. Therefore, the test method of the invention can effectively simplify the test procedure and avoid the prior-art drawback that the audio source is not stable or constant and the operator easily omits to test a sound channel or gets confused about the test result.

The method for testing an audio jack of a portable electronic device according to the preferred embodiment of the invention has the following advantages:

1. One of the sound channels and the microphone MIC are shorted to each other to form a loop in order that the sound playing and recording can be performed in synchronization. Thus, the required test steps can be reduced. That is, it requires only two operations of synchronously playing sound via the left (or right) sound channel and recording, and playing the recorded sound via the right (or left) sound channel, unlike the prior-art technology which needs three operations of recording, left-channel playing and right-channel playing.

2. The audio source for recording is changed from an external audio source to the designated audio file played by the computer under test, and thus the audio source can be unified and generate stable sound, thereby increasing the correctness of the test result.

3. The operator only needs to judge a single final result about whether the speaker generates the designated sound in order to complete the test. Thus, the judgment of the test result can be simplified and the drawback that the operator easily omits some test and gets confused about the test result can be avoided to increase the efficiency of the whole test procedure.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for testing an audio jack of a portable electronic device, the audio jack having a first sound channel, a second channel and a microphone, the method comprising:
(a) controlling the first sound channel to play a designated audio file by the portable electronic device;
(b) recording the played sound into another recorded audio file by the portable electronic device at the same when the first sound channel is playing the designated audio file;
(c) playing the another recorded audio file via the second sound channel by the portable electronic device; and
(d) determining whether the another recorded audio file that is played matches with the designated audio file, and if the audio files match, it represents that the first sound channel, the second sound channel and the microphone have normal function.

2. The method according to claim 1, wherein before the step (a), the method further comprises providing a test cable for connecting with the audio jack, the test cable comprises a first channel line, a second channel line and a microphone signal line respectively corresponding to the first sound channel, the second sound channel and the microphone, and the first channel line and the microphone signal line are shorted to each other.

3. The method according to claim 2, wherein the step (c) further comprises playing the another recorded audio file through a speaker connected to the test cable.

4. The method according to claim 1, wherein the steps (a) and (b) are performed by an internal program of the portable electronic device.

5. The method according to claim 1, wherein the step (b) further comprises setting the second sound channel to be mute.

6. The method according to claim 1, wherein the step (c) further comprises continuously playing the another recorded audio file for a predetermined period of time.

7. The method according to claim 1, further comprising:
if the another recorded audio file that is played does not match with the designated audio file, it represents that at least one of the first sound channel, the second sound channel and the microphone has malfunction and needs to be repaired.

8. The method according to claim 1, wherein the portable electronic device is a tablet computer.
